(19) United States
(12) Patent Application Publication
(10) Pub. No.: US 2002/0116519 A1
(43) Pub. Date: Aug. 22, 2002

(54) Method, apparatus and system for transmitting compressed digital media in a secured manner

(75) Inventor: Yangbin Wang, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EnjoyWeb, Inc., Milpitas, CA (US)

(21) Appl. No.: 10/060,034

(22) Filed: Jan. 28, 2002

Related U.S. Application Data
(60) Provisional application No. 60/265,031, filed on Jan. 29, 2001.

(51) Int. Cl. G06F 15/16

(52) U.S. Cl. 709/231

(57) ABSTRACT

A method (and system) for transmitting streaming media through a network of computers in a secured manner to a client device, e.g., computer, work station, personal digital assistant, cellular phone, television. The method includes transferring streaming media, which has control information and data information. The method also includes removing one or more bits from one or more packets from the streaming media to form a masked version of the streaming media, which cannot be displayed to produce a clear output. A step of transferring the masked version of the streaming media to the client device over a network is included. The method converts the masked version of the streaming media to a display format; and displays the masked version of the streaming media in the display format where the masked version of streaming media producing an incomplete output of the streaming media. The incomplete output of the streaming media is difficult to see clearly.

### CROSS REFERENCE TO RELATED APPLICATION

This application claims priority from the following application: U.S. Provisional Application Serial No. 60/265,031, filed Jan. 29, 2001, in the name of Yangbin Wang, entitled, “Method, Apparatus and System for Trasmitting Compressed Digital Media in a secure Manner,” which is commonly owned and hereby incorporated by reference for all purposes.

### BACKGROUND OF THE INVENTION

The present invention relates to information distribution in a secured manner. More particularly, the invention provides a technique (including a method and system) for creating secured digital media from a media source. The secured digital media are absent of selected bits, which would be desirable to provide a clear output of such media on a display device. By way of removing the selected bits, the compressed digital media can be distributed through a network of computers or other ways without a possibility of unauthorized copying. Even if such copying did occur, the media without bits would have limited usefulness.

As electronic technology progresses, we have seen many wonderful changes in society. Information of all kinds are now readily available and can be accessed by anyone connected to a world wide network of computers, commonly known as the Internet. Many of our daily needs appear to be satisfied using the Internet. For example, we can order groceries through one of the on-line grocery stores, such as “Webvan” from the Webvan Group, Inc. Telephone calls can also be made through the Internet. People have met and even been married through the Internet. Books, CDs, cars, and the like can be purchased through the Internet.

Unfortunately, there have been some drawbacks to conventional brick and mortar companies such as conventional music recording companies with the Internet. In 1999, a famous company called Napster of Redwood City, Calif. 94063 developed software where electronic music files, which are commonly known as MP3 files, could be exchanged or swapped through the Internet free of charge. Suddenly, there was an explosion of music swapping from one client computer to another client computer throughout the world. The music industry was outraged since music was being distributed free from any royalty payments. After some long extended court battles and the like, there has been some peace between Napster and the music industry.

Now recent breakthroughs in video compression technologies are expected to extend the Internet to the video realm by allowing customers to receive literally hundreds of video channels in their homes. While the prospects of opening a whole new world of information to the average person are exciting, there is much concern from the conventional movie industry that the average person will simply be able to swap movie videos with each other free of charge. Any commercial exploitation of movie videos free of charge is indicated as being a violation of copyright laws. Unfortunately, it would be extremely difficult for the movie industry to stop average people from swapping one movie video file with another in an easy and cost effective manner.

A similar difficulty has already occurred in the cable television industry. Many unauthorized uses of move channels have developed through the cable television network. To combat such unauthorized uses, the cable television industry has developed scrambling techniques to prevent a clear broadcast of selected movie channels, which are often premium movie channels, such as Showtime™, HBO™, Playboy™, and others. Here, the channel is often scrambled at a cable head-end and is de-scrambled at the box, which sits at a home. Although such scrambling techniques have had some success, computer pirates known as hackers could still decode the scrambling techniques to de-scramble the scrambled channel. The hackers could then make thousands of unauthorized boxes with such de-scrambling technique to facilitate the unauthorized use of such channel. Similarly, computer pirates or hackers could also decode compressed digital videos distributed through the Internet for free distribution and output to millions of homes. The free distribution of such digital videos causes large monetary losses to conventional movie companies that spend millions to hundreds of millions of U.S. dollars developing such digital videos.

Therefore, what is really needed are methods and systems that can be used to provide security to digital media to prevent any unauthorized use of such media.

### SUMMARY OF THE INVENTION

According to the present invention, a technique including a method and system for providing security to media is provided. More particularly, the invention provides a technique (including a method and system) for creating secured compressed digital media (e.g., video, digital video, MPEG files) from media source, e.g., server, video distribution center. The secured media are absent of selected bits, which would be desirable to provide a clear output of such media on display devices, e.g., television, computer. Since the secured media are absent of such bits, it is extremely difficult to recreate the bits, which are generally required to make the media clear upon output and/or display.

In a specific embodiment, the invention provides a method for transmitting streaming media through a network of computers in a secured manner to a client device, e.g., computer, work station, personal digital assistant, cellular phone, television. The method includes transferring streaming media, which have control information and data information. The method also includes removing one or more bits from one or more packets from the streaming media to form a masked version of the streaming media, which cannot be displayed to produce a clear output. Alternatively, the one or more bits can be replaced with others, which are designed to secure the streaming media. A step of transferring the masked version of the streaming media to the client device over a network is included. The method converts the masked version of the streaming media to a display format; and displays the masked version of the streaming media in the display format where the masked version of streaming media produce an incomplete output of the streaming media. The incomplete output of the streaming media is difficult to see clearly.

In an alternative embodiment, the invention provides a method for providing security to compressed digital media. The method includes removing (or substituting) one or more bits from compressed digital media to form a masked compressed digital media to make the compressed digital media substantially inoperable. The method transfers the one or more bits to combine with the masked compressed digital media to make the masked compressed digital media operable or useful again. Before adding the bits back to the media, the masked compressed digital media are often difficult to recreate and provide a secured form for transferring through a world wide network of computers, which may not have any security.

In a further embodiment, the invention provides a system for securing compressed digital media. The system includes a medium for computer codes. The codes include at least a first code directed to removing (or substituting) one or more bits from compressed digital media to form a masked compressed digital media to make the compressed digital media substantially inoperable. The system also has a second code directed to transferring the masked compressed digital media; and a third code directed to transferring the one or more bits to combine with the masked compressed digital media to make the masked compressed digital media operable again. These and other codes can be used to carry out the functionality described herein, as well as others.

Numerous benefits are achieved by way of the present invention over conventional techniques. The present invention can be implemented using conventional technology, which is available at low cost. Additionally, the invention provides a way to make, for example, a video program (e.g., movie, song) secure, where a hacker cannot recreate the video since important portions of the video are missing. That is, the hacker would need to be an artist to recreate the missing portions of video, which makes the video substantially useless and therefore secure. The invention is relatively easy to implement and should be relatively cost effective. Depending upon the embodiment, there can be one or more of these benefits. These and other benefits are described throughout the present specification and more particularly below.

A further understanding of the nature and advantages of the invention herein may be realized by reference to the remaining portions of the specification and the attached drawings.

### BRIEF DESCRIPTION OF THE DRAWINGS

FIG. 1 is a simplified diagram of a system according to the present invention;

FIG. 2 is a more detailed diagram of a client device according to an embodiment of the present invention;

FIG. 2A is a more detailed diagram of the client device according to an embodiment of the present invention;

FIG. 3 is a detailed diagram of a method according to an embodiment of the present invention;

FIG. 4 is a simplified diagram of a method according to an alternative embodiment of the present invention;

FIG. 5 is a simplified flow diagram illustrating a method according to an alternative embodiment of the present invention;

FIG. 6 is a simplified flow diagram illustrating a method according to an alternative embodiment of the present invention; and

FIG. 7 is a simplified diagram of a picture according to an embodiment of the present invention

### DESCRIPTION OF THE SPECIFIC EMBODIMENTS

According to the present invention, a technique including a method and system for providing security to digital media is provided. More particularly, the invention provides a technique (including a method and system) for creating secured compressed digital media (e.g., video, digital video, MPEG files) from a media source, e.g., server, video distribution center. The secured media are absent of selected bits, which would be desirable to provide a clear output of such media on a display device. Since the secured media are absent of such bits, it is extremely difficult to recreate the bits, which are generally required to make the media clear upon output and/or display. As merely an example, it would take an artist to recreate such bits, which are generally portions of the acutal video.

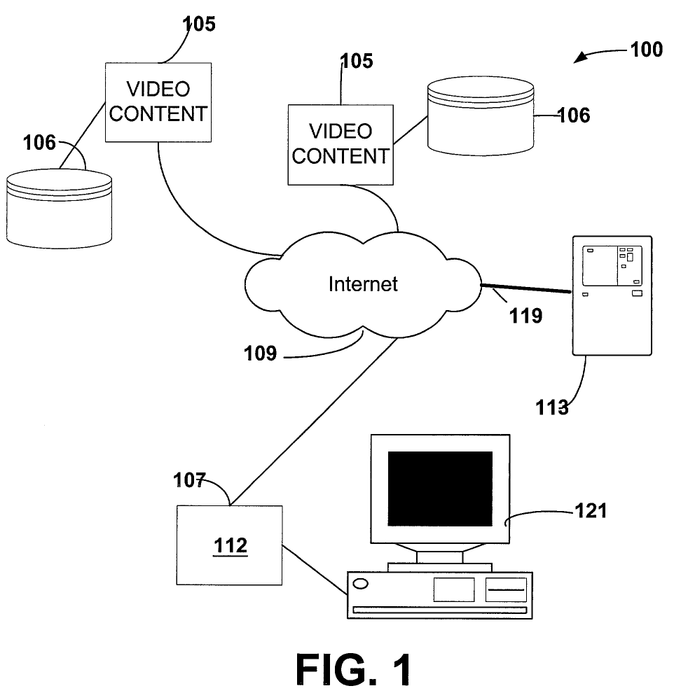

FIG. 1 is a simplified diagram of a system 100 according to the present invention. This diagram is merely an example which should not limit the scope of the claims herein. One of ordinary skill in the art would recognize many other alternatives, variations, and modifications. As shown, the system 100 has a variety of systems and sub-systems. For example, the system has a management server 113, which is coupled to a world wide network of computers, such as the Internet 109. The management system can also be coupled to a cable television network, a local area network, a wireless network, any combination of these, and the like. Here, the management server is coupled to the Internet via line 119, which is a hard wire, cable, etc. The management server can carryout a number of management functions such as overseeing the functions described herein as well as others. In some embodiments, there may not need to be a management server.

The system also has a plurality of video content servers 105. The video content servers are also coupled to the Internet. Although more than one content server is shown, there can be only a single content server in some applications. The video content server is coupled to a video content source, such as database 106. The database can store information such as digital video, digital audio, and other forms of information. Preferably, the database stores digital video, which can be streamed from the content server to one or more client devices. The streaming video can be broadcast, uni-cast, or any combination of these techniques.

A client device 121 is coupled to the Internet through a client server device 112. The client device can include a variety of devices, such as television, a personal computer, a personal digital assistant, a cellular phone, among others. The client server device can be one such as a Web accelerator product made by EnjoyWeb Inc. of Sunnyvale, Calif. The client server device can also be almost any personal computer product, including a microprocessor and storage. The computer also needs a network interface device, which couples to the Internet. The storage can be any suitable size for storing digital video information.

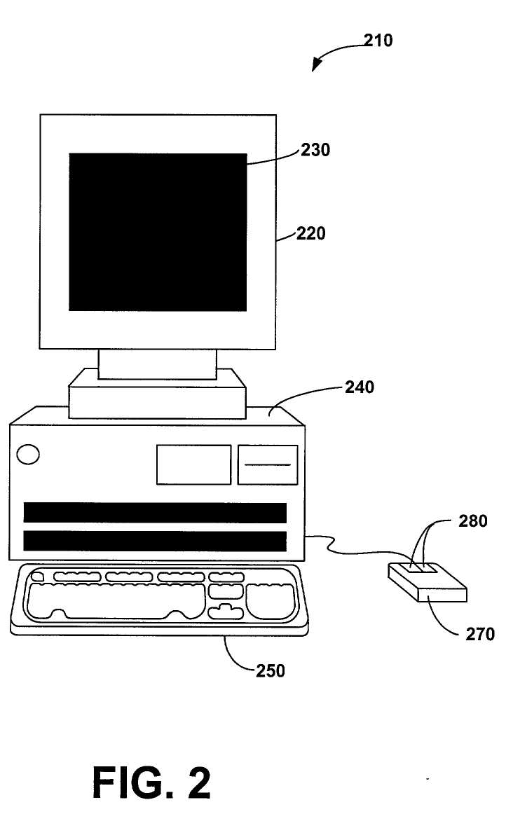

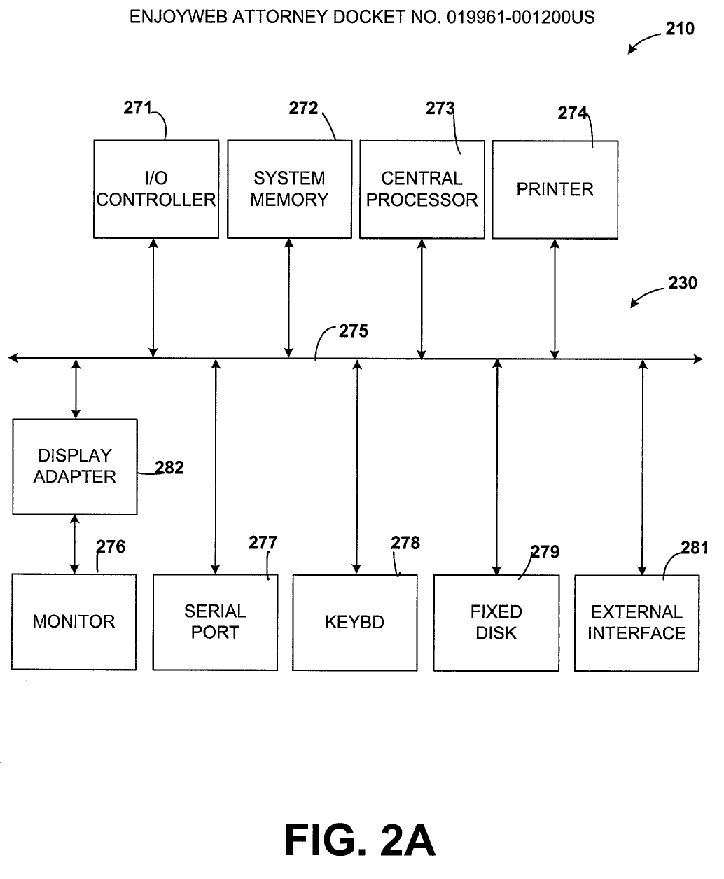

FIG. 2 is a more detailed diagram of a client device 210 according to an embodiment of the present invention. This diagram is merely an example which should not limit the scope of the claims herein One of ordinary skill in the art would recognize many other alternatives, variations, and modifications. Embodiments according to the present invention can be implemented in a single application program such as a browser, or can be implemented as multiple programs in a distributed computing environment, such as a workstation, personal computer or a remote terminal in a client server relationship. FIG. 2 shows computer system 210 including display device 220, display screen 230, cabinet 240, keyboard 250, scanner and mouse 270. Mouse 270 and keyboard 250 are representative “user input devices.” Mouse 270 includes buttons 280 for selection of buttons on a graphical user interface device. Other examples of user input devices are a touch screen, light pen, track ball, data glove, microphone, and so forth.

FIG. 2 is representative of but one type of system for embodying the present invention. It will be readily apparent to one of ordinary skill in the art that many system types and configurations are suitable for use in conjunction with the present invention. In a preferred embodiment, computer system 210 includes a Pentium™ class based computer, running Windows™ NT operating system by Microsoft Corporation. However, the apparatus is easily adapted to other operating systems and architectures by those of ordinary skill in the art without departing from the scope of the present invention. As noted, mouse 270 can have one or more buttons such as buttons 280. Cabinet 240 houses familiar computer components such as disk drives, a processor, storage device, etc. Storage devices include, but are not limited to, disk drives, magnetic tape, solid state memory, bubble memory, etc. Cabinet 240 can include additional hardware such as input/output (I/O) interface cards for connecting computer system 210 to external devices external storage, other computers or additional peripherals, which are further described below.

FIG. 2A is an illustration of basic subsystems in computer system 210 of FIG. 2. This diagram is merely an illustration and should not limit the scope of the claims herein. One of ordinary skill in the art will recognize other variations, modifications, and alternatives. In certain embodiments, the subsystems are interconnected via a system bus 275. Additional subsystems such as a printer 274, keyboard 278, fixed disk 279, monitor 276, which is coupled to display adapter 282, and others are shown. Peripherals and input/output (I/O) devices, which couple to I/O controller 271, can be connected to the computer system by any number of means known in the art, such as serial port 277. For example, serial port 277 can be used to connect the computer system to a modem 281, which in turn connects to a wide area network such as the Internet, a mouse input device, or a scanner. The interconnection via system bus allows central processor 273 to communicate with each subsystem and to control the execution of instructions from system memory 272 or the fixed disk 279, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

Although the above has been illustrated in terms of specific hardware features, it would be recognized that many variations, alternatives, and modifications can exist. For example, any of the hardware features can be further combined, or even separated. The features can also be implemented, in part, through software or a combination of hardware and software. The hardware and software can be further integrated or less integrated depending upon the application. Further details of the functionality of the present invention can be outlined below according to the Figs.

A method according to an embodiment of the present invention may be outlined as follows:

1. Provide a streaming media source (e.g., audio, MPEG-2, MPEG-4. digital video) from a first server;

2. Transfer the streaming media from the first server, where the streaming media includes data and control bits;

3. Remove one or more bits of data and/or one or more control bits from each packet of the streaming media to form a masked version of the streaming media, which is the streaming media without the one or more bits;

4. Store the one or more bits at a second server;

5. Transfer the masked streaming media to a client device through a first route to a client device;

6. Buffer the masked streaming media at the client device (optional);

7. Request for the one or more bits from the second server by the client device;

8. Transfer the one or more bits from the second server to the client device;

9. Buffer the one or more bits at the client device (optional);

10. Combine the masked streaming media with the one or more bits of data to reform the streaming media;

11. Convert the streaming media into a display format;

12. Output the streaming media on a display device of the client; and

13. Perform other steps, as desirable.

The above sequence of steps is merely an example of the present method. The method removes one or more bits from, for example, compressed digital media, which make it substantially inoperative. The inoperative media are called herein as a masked digital medium or media. The one or more bits can be later combined with the masked digital media to reform the compressed digital media. Once the media are decompressed, it is ready for display at an output device. These and other details of the invention are provided in reference to the Figs. below.

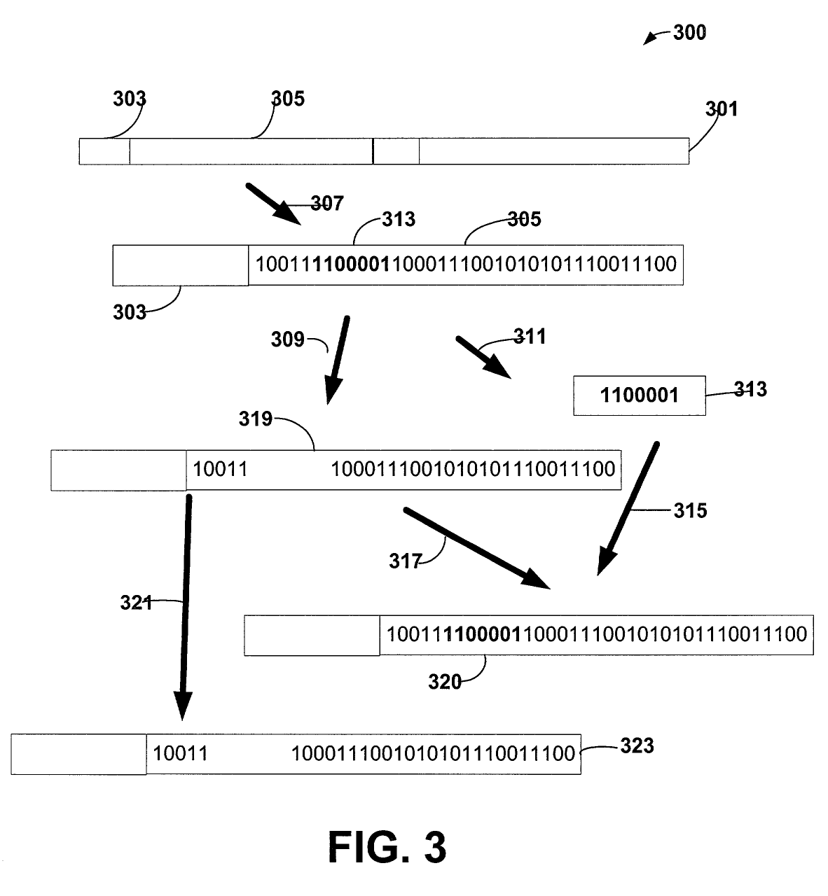

FIG. 3 is a detailed diagram of a method 300 according to an embodiment of the present invention. This diagram is merely an example which should not limit the scope of the claims herein. One of ordinary skill in the art would recognize many other alternatives, variations, and modifications. As shown, the method illustrates data that are derived from compressed data 301. The compressed data includes a header 303 and an information 305 or content section. The header often has control information. The content section has, for example, a movie or the like. The compressed data can be compressed digital media, e.g., digital video, digital audio, digital information, digital data.

According to the present method, the content section includes a series of information bits 305. The information bits can be made of almost any coding technique, e.g., MPEG-2, MPEG-4. For example, the information bits can be comprised of ones and zeros, as shown. In a specific embodiment, the information bits can include a section of ones and zeros in a portion shown by reference numeral 313. These ones and zeros include “110001” but can be others, depending upon the embodiment, and should not in any way limit the scope of the claims herein.

The method removes the portion 313 of bits, which are information bits. The remaining portion of the compressed digital media 319 are now separated from the one or more removed bits. In a specific embodiment, the method relies upon the missing bits to form a substantially useless stream of media, which make such useless media secure. That is, since the compressed digital media are highly compact, removing the one or more bits makes the digital media almost or completely worthless to a conventional user. Here, a user of the digital media, which do not include the bits, can not output the digital media in a manner where the output is easy to understand or even comprehend, therefore taking any real entertainment value out of the media. In an example where the media are video, the user would see a video that is not understandable and lacks entertainment value. Similarly in an example where the media are audio, the user would listen to audio that is not understandable and therefore looses value. Since the output is not understandable, it is practially secure. As shown, the method transfers 321 a compressed digital media 323, which generally cannot be decompressed into a useful form.

Alternatively, the method combines the removed portion of bits 313 with the compressed digital media 319, which do not have the bits. The method transfers 315 the removed portion of bits to a location to combine these removed bits with the digital media without the bits. The method transfers 319 the digital media without bits to the same location, where the removed bits are combined back with the digital media without the bits to form the compressed digital media 320. The compressed media are then decompressed for output on an output device. Since the compressed media are complete, it can be decompressed to form a useful output.

Although the above can be performed using a combination of specific hardware and software features, it would be recognized that many variations, alternatives, and modifications can exist. For example, any of the hardware features can be further combined, or even separated in either hardware or software. The features can also be implemented, in part, through software or a combination of hardware and software. The hardware and software can be further integrated or less integrated depending upon the application.

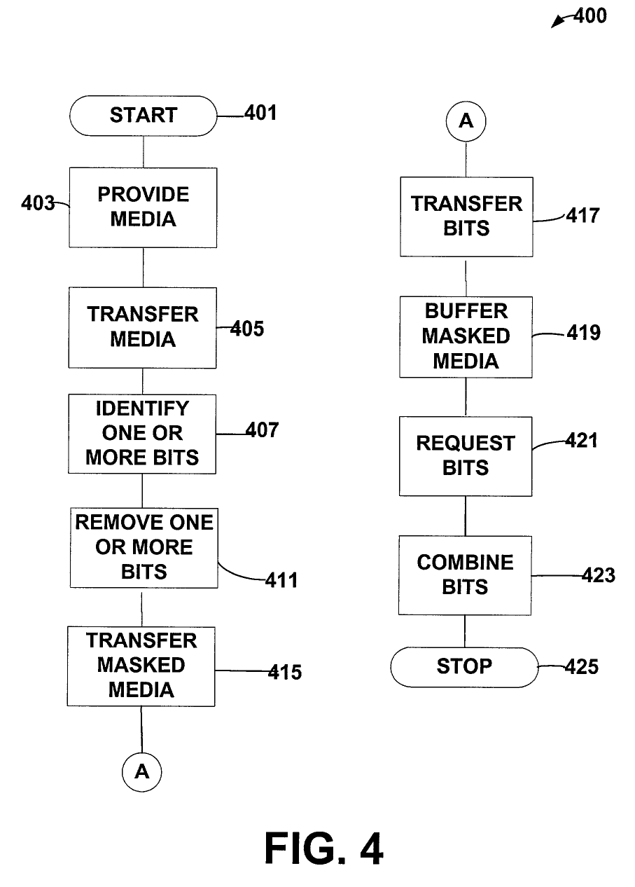

FIG. 4 is a simplified diagram 400 of a method according to an alternative embodiment of the present invention. This diagram is merely an example which should not limit the scope of the claims herein. One of ordinary skill in the art would recognize many other alternatives, variations, and modifications. The method begins with start, step 401. As shown, the method provides compressed digital data (at step 403). In some embodiments, the compressed data includes a header and content information. The compressed data can be compressed digital media such as digital video, digital audio, digital information, digital data.

According to the present method, the content section includes a series of information bits. The information bits can be made of almost any coding technique, e.g., MPEG-2, MPEG-4. For example, the information bits can be comprised of ones and zeros. In a specific embodiment, the information bits can include a section of ones and zeros. These ones and zeros include “110001” but can be others, depending upon the embodiment, and should not in any way limit the scope of the claims herein. The method transfers (step 405) the media in some embodiments. Here, the transfer occurs to a processing engine, for example, which identifies (step 407) one or more bits to be removed. The removed bits may be routed through one or more paths, which do not come together with the other portion of the media in an unsecured manner. The path or paths may be under control of or through a management server, such as the one noted above, but can be others. Additionally, the management server can be combined with the content server in some embodiments or any other servers. Some embodiments may not include servers at all.

The method removes a portion of bits, which are information bits, but can be header information as well, or a combination of information bits and header information. The remaining portion of the compressed digital media are now separated from the one or more removed bits. We call this remaining portion a masked media, as noted. This term is not intended to be limiting in any manner and is merely provided for illustrative purposes only.

In a specific embodiment, the method relies upon the missing bits to secure the compressed digital media. That is, since the compressed digital media are highly compact, removing the one or more bits makes the digital media almost or completely worthless to a conventional user. Here, a user of the digital media, which do not include the bits, can not output the digital media to a form that is easy to understand. In an example where the media are video, the user would see a video that is not understandable and lacks entertainment value. Similarly in an example where the media are audio, the user would listen to audio that is not understandable and lacks any information value. Since the output is not understandable, it is secure and has substantially no usefulness. As shown, the method transfers (step 415) the compressed digital medium, which generally cannot be decompressed into a useful media. The method transfers the masked media through an unsecured network so potential hackers are free to intercept the masked media, but will generally be useless to the hacker. The method goes onto the next process.

The method then transfers (step 417) the one or more bits, which may be from the content server to a management server for storage or caching purposes. Alterntively, the content server may store the one or more bits and hold them until they are requested by a user. At the client location the user requests for a video, which is the masked media, which may be buffered (step 419) at a client device or a client server, which has also be described above. Once the masked media have been sent to the client device or have been requested, the method also requests (step 421) for the one or more missing bits. Now, the masked media and the one or more missing bits are together at the same location.

The method combines (step 423) the one or more missing bits with the masked media to reform the compressed digital media, which may be compressed or decompressed by now. The compressed digital media are decompressed, if not so already, and then processed into a format for output. Since the compressed media are complete, it can be decompressed to form a useful output. The output can be in the form of a video such as a movie or the like. The method ends at stop, step 425.

Although the above can be performed using a combination of specific hardware and software features, it would be recognized that many variations, alternatives, and modifications can exist. For example, any of the hardware features can be further combined, or even separated in either hardware or software. The features can also be implemented, in part, through software or a combination of hardware and software. The hardware and software can be further integrated or less integrated depending upon the application.

A method according to an alternative embodiment of the invention can be outlined as follows:

1. Select a video in a masked compressed digital format (e.g., audio, MPEG-2, MPEG-4. digital video) from a first server;

2. Transfer the masked compressed digital media from the first server to a client device;

3. Request for the one or more bits that have been removed from the masked compressed format of the video;

4. Transfer the bits to the client device;

5. If the one or more bits are for the masked media, combine the one or more bits with the masked media;

6. If the one or more bits are not for the masked media, return to the requesting step;

7. Convert the compressed media into a display output format;

8. Output the media on the client device; and

9. Perform other steps, as desirable.

The above sequence of steps is merely an example of the present method. The method requests for one or more bits to combine with a masked compressed digital media, which are substantially inoperative without such one or more bits. The inoperative media are called herein as the masked digital medium or media or masked video or audio. The one or more bits can be combined with the masked digital media to reform the compressed digital media. Once the media are decompressed with the one or more bits, it is ready for display at an output device. These and other details of the invention are provided in reference to the Figs. below.

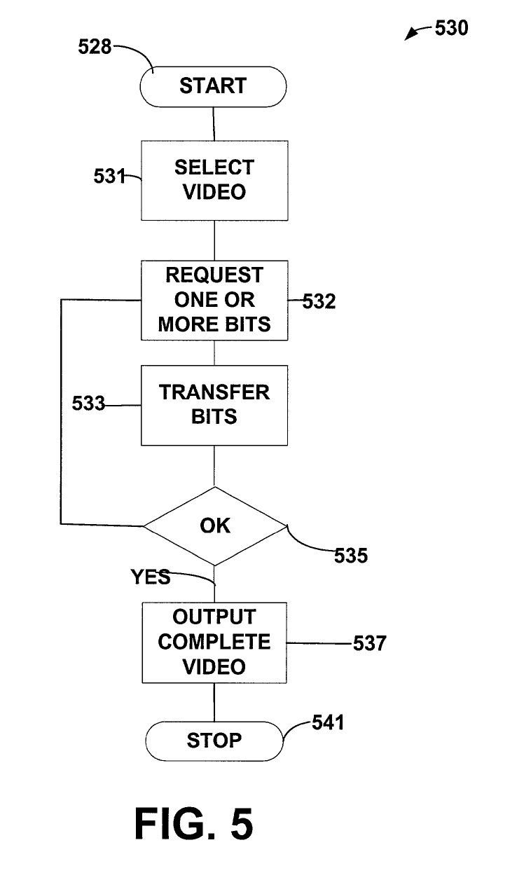

FIG. 5 is a simplified flow diagram 530 illustrating a method according to an alternative embodiment of the present invention. This diagram is merely an example which should not limit the scope of the claims herein. One of ordinary skill in the art would recognize many other alternatives, variations, and modifications. The method begins with start, step 528. The method provides compressed digital data, which are masked for security purposes.

In some embodiments, the masked compressed data includes a header and content information. The masked compressed data can be compressed digital media such as digital video, digital audio, digital information, digital data. According to the present method, the content section includes a series of information bits. The information bits can be made of almost any coding technique, e.g., MPEG-2, MPEG-4. For example, the information bits can be comprised of ones and zeros, as shown. In a specific embodiment, the information bits can include a section of ones and zeros. These ones and zeros include “110001” but can be others, depending upon the embodiment, and should not in any way limit the scope of the claims herein. The masked compressed data can be in almost any form. For example, the data can be on a hard media such as a disk, tape, or the like. Alternatively, the data can be in a soft form such as a file on a server, juke box, or the like. Depending upon the specific application, one of ordinary skill in the art would recognize many other modifications, variations, and alternatives for the form of the masked digital media.

In a specific embodiment, the method relies upon the missing bits of the masked digital media to secure the compressed digital media. That is, since the compressed digital media are highly compact, removing the one or more bits makes the digital medium almost or completely worthless to a conventional user. Here, a user of the digital media, which do not include the bits, can not output the digital media where the output is easy to understand. In an example where the media are video, the user would see a video that is not understandable and lacks any real entertainment value. Similarly in an example where the media are audio, the user would listen to audio that is not understandable and also lacks real entertainment value. Since the output is not understandable and lacks usefulness, it is practially secure. The method transfers the compressed digital media, which generally cannot be decompressed into a useful form. The method transfers the masked media through an unsecured network so potential hackers are free to intercept the masked media, but will generally be useless to the hacker. Alternatively, if the media are on a hard form such as a disk, the media can be physically routed but cannot be played in an efficient manner. The method goes onto the next process.

The method requests (step 532) the one or more bits, which may be from the content server to a management server, which storages or caches the one or more bits. The content server can also store the one or more bits. In a specific embodiment, the one or more bits are transferred (step 533) from the content server to the management server, such as the one noted above. At the client location the user requests for the one or more missing bits, once the user decides on specific media to be output. Once the masked media have been sent to the client device, the masked media and the one or more missing bits are together at the same location.

The method then goes through a decision process, step 535. If the one or more bits are correctly for the masked media, the method combines the one or more bits with the masked media. Alternatively, if the one or more bits are not for the masked media, the method returns to the requesting step 535. The method combines the one or more missing bits with the masked media to reform the compressed digital media, which may be compressed or decompressed by now. The compressed digital media are decompressed, if not so already, and then processed into a format for output. Since the compressed media are complete, it can be decompressed to form a useful output, step 537. The output can be in the form of a video such as a movie or the like. The method ends at stop, step 541.

Although the above can be performed using a combination of specific hardware and software features, it would be recognized that many variations, alternatives, and modifications can exist. For example, any of the hardware features can be further combined, or even separated in either hardware or software. The features can also be implemented, in part, through software or a combination of hardware and software. The hardware and software can be further integrated or less integrated depending upon the application.

A method according to an alternative embodiment of the present invention may be outlined as follows:

1. Provide a compressed media source (e.g., audio, MPEG-2, MPEG-4);

2. Remove one or more bits of data and/or one or more control bits from each packet of the compressed media to form masked media;

3. Add dummy bits in place of the one or more bits (optional);

4. Scramble the masked streaming media (optional);

5. Transfer the masked media (which may be scrambled and/or which may also include dummy bits) through a world wide network of computers or other distribution channel; and

6. Perform other steps, as desirable.

The above sequence of steps is merely an example of the present method. The method removes one or more bits from compressed digital media, which becomes substantially inoperative without such one or more bits. The inoperative media are called herein as the masked digital medium or media or masked video or audio. The one or more bits can be combined with the masked digital medium to reform the compressed digital medium. Once the media are decompressed with the one or more bits, it is ready for display at an output device. In other embodiments, the method replaces the one or more removed bits with dummy bits, which make the masked media even more inoperative or can provide some functionality. In other embodiments, the method also scrambles with compressed digital media without the one or more bits for even more security. These and other details of the invention are provided in reference to the Figs. below.

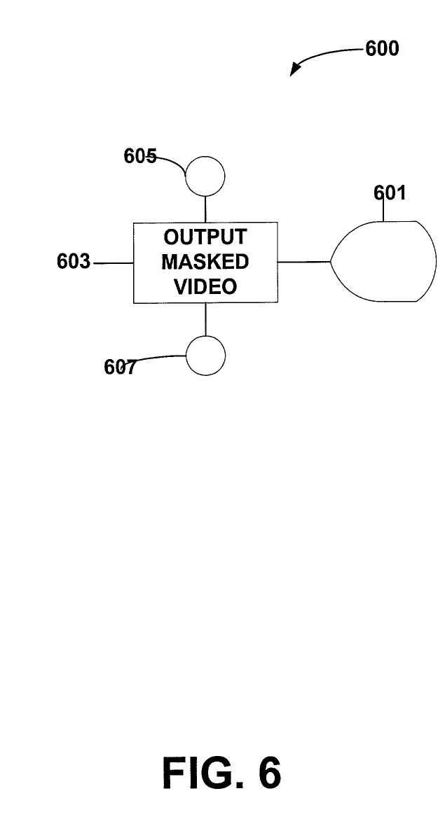

FIG. 6 is a simplified flow diagram 600 illustrating a method according to an alternative embodiment of the present invention. This diagram is merely an example which should not limit the scope of the claims herein One of ordinary skill in the art would recognize many other alternatives, variations, and modifications. In the present method, we provide a way for distributing a compressed video, for example, in a secured manner. The method receives the compressed video from a source 605. The source can be from a server on a world wide network of computers, a digital video disk, or any others. The compressed video is masked, as defined herein. The masked video is missing one or more bits, which make the video incomprehensible. In some embodiments, the missing bits may be replaced by dummy bits, which make the video even more incomprehensible. The dummy bits can also have some functionality associated with them, which may be useful for one or more purposes, but not useful for viewing the video.

In a specific embodiment, the method can also scramble the masked digital media. Depending upon the embodiment, a variety of conventional and unconventional scrambling techniques may be used. The combination of the one or more missing bits and scrambling provide even more security to the media. Additionally, the scrambling technique can also be combined with the masked media having dummy bits. One would recognize that there would be many variations, modifications, and alternatives to using dummy bits, missing bits, scrambling, and the like to provide further security to the digital media.

The method then decompresses the video for output, step 603. The decompressed video also has missing information based upon the missing one or more bits from the compressed video. The method outputs (step 601) the video on a display device. Since the video has missing information, it is not understandable and lacks any usefulness and/or entertainment value to an ordinary user. Accordingly, the method provides a secure way of transporting a compressed video file.

The method also can distribute the masked video to another user, step 607. The other user can access the masked video through the network of computers, through a fixed media source, or other source. The other user goes through the same steps, as shown above. Here, the method decompresses the video for output. The decompressed video has missing information based upon the missing one or more bits from the compressed video. The method outputs the video on a display device. Since the video has missing information, it is not understandable and lacks any usefulness to the other user. Accordingly, the method provides a secure way of transporting a compressed video file.

Although the above can be performed using a combination of specific hardware and software features, it would be recognized that many variations, alternatives, and modifications can exist. For example, any of the hardware features can be further combined, or even separated in either hardware or software. The features can also be implemented, in part, through software or a combination of hardware and software. The hardware and software can be further integrated or less integrated depending upon the application.

Experiments:

To prove the principle and operation of the present invention, we performed an experiment. The experiment is merely an example which should not unduly limit the scope of the claims herein. One of ordinary skill in the art would recognize many other variations, alternatives, and modifications. The experiment has been performed to fully show the benefits of the invention. For easy reading, we provided descriptions of our invention below under the bolded headings.

I. Description:

We obtained a MPEG file from the public domain. This file, named “ts_original.mpg”, is one of the official MPEG bitstreams used in MPEG conformance testing. The total size of this file is 30,300 bytes. We ran this file through a filter that stripes one byte out of 1000 bytes and output the results into two files. The first file contains 30,270 bytes, or 99.9% of data in the original file. The second file contains 30 bytes, or 0.1% of the data in the original file. We verified that the first file is not playable because of missing the 0.1% data that is contained in the second file.

II. Experimental Results:

We experimented with the three files below:

“ts_original.mpg”—original MPEG bitstream;

“ts_masked.mpg”—masked MPEG bitstream where 0.1% of data from the original MPEG bitstream is striped;

“ts_residual.mpg”—residual MPEG bitstream that contains the data removed from the original MPEG bitstream.

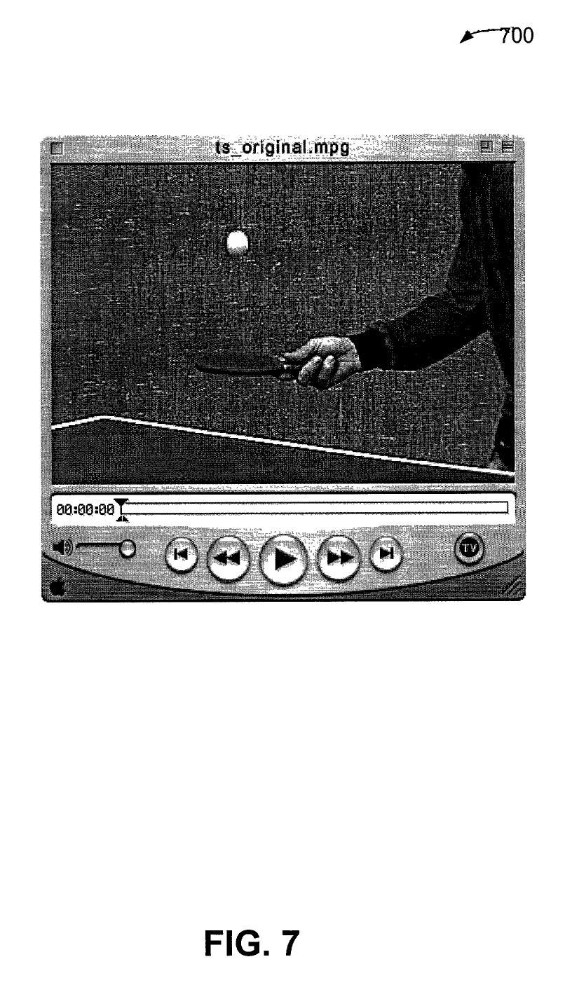

Referring to FIG. 7, we output the picture 700 that shows the first frame of the original MPEG bitstream, “ts_original.mpg”. We could not show picture from masked MPEG bitstream, “ts_masked.mpg” because it was not decodable.

In conclusion, the present invention provides ways for forming secured digital media in an easy and cost effective manner. In the foregoing specification, the invention has been described with reference to a specific representative embodiments thereof. Many changes or modifications are readily apparent to those of ordinary skill in the art. For example, changing the size or arrangement of the computer systems, information object pump and the like, changing the network protocols, network topologies and the like; adding audio, visual effects to the operating components are included within other embodiments of the present invention. It will be evident, however, that various modifications and changes may be made thereunto without departing from the broader spirit and scope of the invention as set forth in the appended claims and their full scope of equivalents.

The specification and drawings are, accordingly, to be regarded in an illustrative rather than in a restrictive sense. For example, some of the embodiments are shown in terms of compressed digital video, but the invention can also be applied to digital audio, digital information, and other forms of compressed digital data. It will, however, be evident that various modifications and changes may be made thereunto without departing from the broader spirit and scope of the invention as set forth in the claims.

What is claimed is:

1. A method for transmitting streaming media through a network of computers in a secured manner to a client device, the method comprising:
transferring streaming media, the streaming media comprising control information and data information;
removing one or more bits from one or more packets from the streaming media to form a masked version of the streaming media; and
transferring the masked version of the streaming media to a client device over a network; and
converting the masked version of the streaming media to a display format;
displaying the masked version of the streaming media in the display format where the masked version of streaming media producing an incomplete output of the streaming media.

2. The method of claim 1 wherein the one or more bits comprise at least one percent or more of the streaming media or at least 0.1% of the streaming media.

3. The method of claim 1 wherein the network comprises a cable television network or a network of computers.

4. The method of claim 1 further comprising recombining the one or more bits with the masked version of the streaming media to reform the streaming media and converting the reformed streaming media into a display format. .

5. The method of claim 4 wherein the streaming media is selected from MPEG-2, MPEG-4, and digital audio.

6. The method of claim 1 wherein the streaming media is compressed digital media.

7. The method of claim 1 wherein the one or more bits comprises content information.

8. The method of claim 1 wherein the incomplete output of the streaming media is substantially free from being understandable such that the incomplete output is substantially free from any usefulness.

9. The method of claim 1 wherein the network of computers is the Internet.

10. The method of claim 1 wherein the client device is selected from a television, a computer, a personal digital assistant, a network computer, and a workstation.

11. A method for providing security to compressed digital media, the method comprising:
removing one or more bits form compressed digital media to form a masked compressed digital media to make the compressed digital media substantially inoperable;
transferring the masked compressed digital media; and
transferring the one or more bits to combine with the masked compressed digital media to make the masked compressed digital media operable.

12. The method of claim 11 wherein the one or more bits comprise at least one percent or more of the compressed digital media.

13. The method of claim 11 wherein the transferring occurs through a network selected from a cable television network or a network of computers.

14. The method of claim 11 the compressed digital media are selected from MPEG-2, MPEG-4, and digital audio.

15. The method of claim 11 further comprising adding dummy one or more bits into the masked compressed digital media.

16. The method of claim 15 further comprising removing the dummy one or more bits from the masked compressed digital media before combining the one or more bits back into the masked compressed digital media.

17. The method of claim 15 wherein the dummy one or more bits comprises information that is substantially free from any usefulness.

18. The method of claim 15 wherein the dummy one or more bits comprises information that provides a security alert.

19. A system for providing security to compressed digital media, the system including a medium for computer codes, the codes include at least:
a first code directed to removing one or more bits form compressed digital media to form a masked compressed digital media to make the compressed digital media substantially inoperable;
a second code directed to transferring the masked compressed digital media; and
a third code directed to transferring the one or more bits to combine with the masked compressed digital media to make the masked compressed digital media operable.

20. The system of claim 19 wherein the computer codes are provided on a single memory or a distributed memory.
